(19) United States
(12) Patent Application Publication
(10) Pub. No.: US 2023/0004977 A1
(43) Pub. Date: Jan. 5, 2023

(54) EXPLOITING GRAPH STRUCTURE TO IMPROVE RESULTS OF ENTITY RESOLUTION

(71) Applicant: Oracle International Corporation, Redwood Shores, CA (US)

(72) Inventors: Miroslav Cepek, Prague (CZ); Iraklis Psaroudakis, Zurich (CH); Nina Corvelo Benz, Kaiserslautern (DE)

(21) Appl. No.: 17/363,515

(22) Filed: Jun. 30, 2021

(51) Int. Cl. G06Q 20/40; G06Q 30/00

(52) U.S. Cl. CPC G06Q 20/4016; G06Q 30/018

(57) ABSTRACT

In an embodiment, a computer stores a bipartite graph that consists of a source subgraph and a target subgraph. Each vertex in the bipartite graph represents an entity. The source subgraph and the target subgraph are connected by many similarity edges. Each similarity edge indicates an original amount of similarity between the entity of a source vertex in the source subgraph and the entity of a target vertex in the target subgraph. For each similarity edge, the computer determines: a set of neighbor source vertices that are reachable from the source vertex of the similarity edge by traversing at most a source radius count of source edges in the source subgraph, a set of neighbor target vertices that are reachable from the target vertex of the similarity edge by traversing at most a target radius count of target edges in the target subgraph, and various amounts based on graph topology. For each similarity edge, the computer calculates a new amount of similarity based on those various amounts.

### FIELD OF THE INVENTION

The present invention relates to entity resolution. Herein are acceleration techniques for recognizing duplicate entities based on a topology of a bipartite graph.

### BACKGROUND

Accuracy of data science and analytics may be limited by the quality of underlying data. Because a single data source may provide somewhat incomplete data, multiple data sources may be used to provide somewhat overlapping data that can be merge to generate a more complete data store. Each data source may provide a different and partial record that logically represents a same entity such as a person, organization, location, or other real world object. Thus, a best representation of an entity may entail combining somewhat similar records from different data sources.

Entity resolution entails deciding whether two records in a database or two vertices in a property graph represent a same entity based on information directly associated with those entities. State of the art approaches for entity resolution may examine information associated with entities, including demographic details such as name, phone number, email address, and postal address and, based on a metric of similarity, decide whether the two records represent a same entity such as a same person. Efficient entity resolution engines may operate in two phases. A first phase is fuzzy (i.e. inexact) and consists of a fast, high-recall (i.e. prone to false positives but not prone to false negatives) search technique for discovering near-duplicates that are candidates for merging. A second phase applies a more thorough comparison of candidates' attributes for high precision matching and merging.

Existing approaches are limited by only examining individual entities. There was no approach that incorporated relationships between entities into entity resolution calculation. Standard entity resolution approaches rely only on finding similarities between entities based on associated demographic information such as name, address, and phone number. The entity relationships are not taken into consideration during entity resolution even though in many use-cases the relationship information between entities is available and could contribute to accuracy of entity resolution. By ignoring entity relationships, accuracy achieved by a fixed processing duration is decreased and a processing duration needed to achieve a fixed accuracy is increased.

### BRIEF DESCRIPTION OF THE DRAWINGS

In the drawings:

FIG. 1 is a block diagram that depicts an example computer that accelerates recognizing duplicate entities based on the topology of a bipartite graph;

FIG. 2 is a flow diagram that depicts an example computer process that accelerates recognizing duplicate entities based on the topology of a bipartite graph;

FIG. 3 depicts pseudocode of step 1 of an example unweighted neighbor counting algorithm;

FIG. 4 depicts pseudocode of step 2 of an example unweighted neighbor counting algorithm;

FIG. 5 is a dataflow diagram that depicts example inputs, outputs, and intermediate data for the example unweighted algorithm;

FIG. 6 is a flow diagram that depicts an example computer process that adjusts amounts of similarity of similarity edges;

FIGS. 7-8 depict pseudocode of step 1 of an example weighted neighbor counting algorithm;

FIG. 9 depicts pseudocode of step 2 of an example weighted neighbor counting algorithm;

FIG. 10 is a dataflow diagram that depicts example inputs, outputs, and intermediate data for the example weighted algorithm;

FIG. 11 is a flow diagram that depicts an example computer process that adjusts amounts of similarity of similarity edges based on weights of all vertices in a bipartite graph;

FIG. 12 is a flow diagram that depicts an example PageRank process that adjusts amounts of similarity of similarity edges based on weights of all vertices in a bipartite graph;

FIG. 13 is a block diagram that illustrates a computer system upon which an embodiment of the invention may be implemented;

FIG. 14 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

Entity resolution decides whether two records or vertices represent a same entity based on information directly assigned to those entities. Techniques herein increase the accuracy and speed of entity resolution by exploring relationships between entities and neighboring entities. In a database embodiment, entity relationships may occur as foreign key relationships. In a graph embodiment, entity relationships may occur as edges that interconnect vertices. Techniques herein are agnostic to the system performing entity resolution, and build on top of already identified matches, as long as there are relationships between entities captured in the underlying data. In an embodiment, techniques herein operate as a post processor that takes existing entity resolution results provided by opaque legacy software and increases the accuracy of those results in various ways such as refining similarity scores of merge candidate entities, erasing false similarities, and creating new similarities.

For regulatory compliance, accurate entity resolution herein may be applied to various important domains such as fraud detection, anti-money laundering, and terrorism finance tracing. Taking entity relationships into account brings additional accuracy, which in turn means more accurate identification of identical entities. For example in financial crime detection, it means that an investigation of a suspicious case can be concluded faster and more accurately.

In a property graph embodiment, the input graph is bipartite such that two vertices respectively in two subgraphs may already be resolved as a same entity as indicated by a synthetic similarity edge was added by a legacy entity resolver to join the two subgraphs by connecting the two vertices. By iteratively expanding a radius of a neighborhood of vertices that surround a vertex that has a similarity edge, entity similarity and relationship information transitively propagates throughout the neighborhood. Thus, information is shared within the neighborhood without explicit graph traversal such depth first or breadth first that entail expensive and/or sequential activities such as accumulating traversal paths or backtracking.

In an unweighted embodiment, a minimum count of entities in one subgraph that are merge candidates with vertices in the other subgraph is detected. In a weighted embodiment, the count is not an integer and is additionally based on weighting coefficients. Various embodiments may derive various metadata such as:
a similarity score for each similarity edge
an indication of which similarity edges have similarity scores that exceed a confidence threshold
an indication of which of multiple similarity edges connected to a same vertex has a highest or lowest similarity score.

To count mergeable entities, each vertex has an expanding set of vertices that have similarity edges in the vertex's neighborhood. Initially the set contains only vertices of similarity edges that are connected to the vertex. In each iteration, each vertex merges its set with that of its neighbors. After a number of specified iterations is finished, how many vertices are in the intersection of source and target sets of each similarity edge are counted.

In a weighted embodiment, each vertex is assigned a vertex weight that does not change. Vertex weights may be computed by undirected PageRank and then transformed into normalized vertex weights. For each vertex, an edge weight that is not a similarity score is assigned to each similarity edge in its neighborhood. In each iteration, each vertex merges its edge weight information with that of its neighbors using a weighted sum.

In a weighted or unweighted embodiment, a computer stores a bipartite graph that consists of a source subgraph and a target subgraph. Each vertex in the bipartite graph represents an entity. The source subgraph and the target subgraph are connected by many similarity edges. Each similarity edge indicates an original amount of similarity between the entity of a source vertex in the source subgraph and the entity of a target vertex in the target subgraph. For each similarity edge, the computer determines:
a) a set of neighbor source vertices that are reachable from the source vertex of the similarity edge by traversing at most a source radius count of source edges in the source subgraph
b) a set of neighbor target vertices that are reachable from the target vertex of the similarity edge by traversing at most a target radius count of target edges in the target subgraph
c) a source amount of vertices in the neighbor source vertices that are connected to any vertex in the neighbor target vertices by any similarity edge
d) a target amount of vertices in the neighbor target vertices that are connected to any vertex in the neighbor source vertices by any similarity edge
e) a lesser amount of vertices that is a minimum of the source amount of vertices and the target amount of vertices.

In the above enumerated determinations are various amounts of vertices that are integer counts in an unweighted embodiment and, instead, are real numbers in a weighted embodiment. For each similarity edge, the computer calculates a new amount of similarity based on the above lesser amount.

### 1.0 EXAMPLE COMPUTER

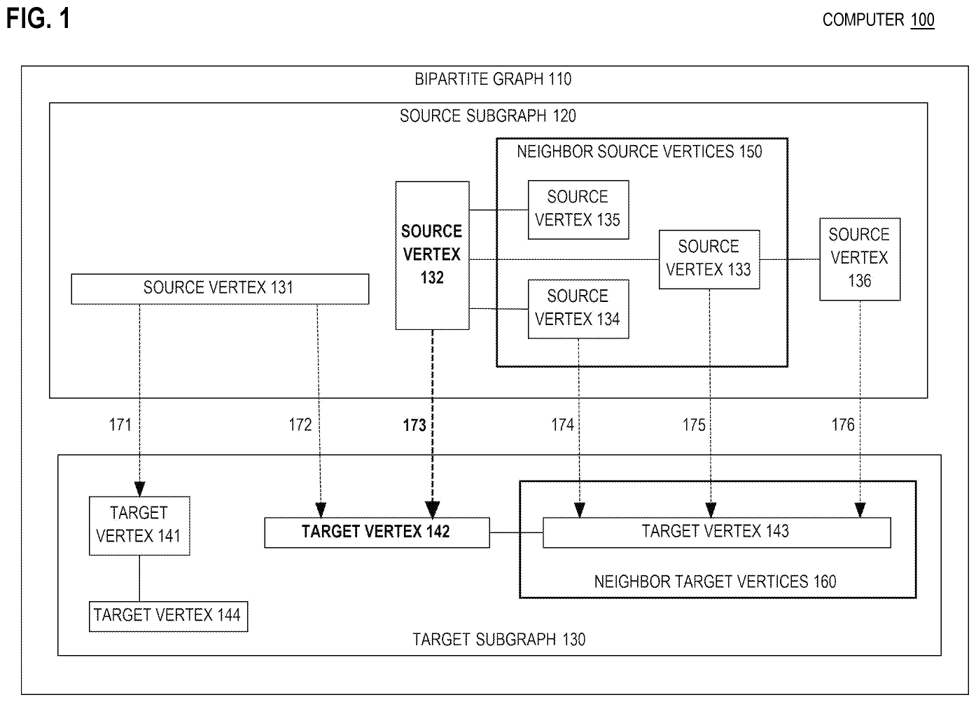

FIG. 1 is a block diagram that depicts an example computer 100, in an embodiment. Computer 100 accelerates recognizing duplicate entities based on the topology of bipartite graph 110. Computer 100 may be one or more of a rack server such as a blade, a personal computer, a mainframe, a virtual computer, or other computing device.

Computer 100 may receive content from multiple data sources (not shown) such as databases, web services, software applications, and filesystems. Each data source may provide structured or unstructured data such as records, documents, spreadsheets, and files that describe entities (not shown). An entity may be a real-world object such as a person, a corporation, a geographic location, an account such as a bank account or a computer account, or a vehicle. Each data source may provide descriptions of associations between entities. Associations may be more or less long-lived, such as which person owns which car, or transactional such as which corporation paid which other corporation.

Although entities are distinct in the real world, universal identifiers of entities may be non-existent or not pervasively used. For example, two data sources may disagree on how a same entity is identified. In some cases, a data source may use an identifier that is not unique. For example, many people may share a same full name. Likewise, a same person may at various times be identified by a full name that variously has a middle name, a middle initial, or neither. Thus, there may be ambiguity as to whether two entities provided by a same or different data source are actually a same entity in the real word.

### 1.1 EXAMPLE GRAPH

To facilitate entity analytics such as recognition of duplicate entities that actually are a same entity, computer 100 stores and uses bipartite graph 110 that contains vertices 131-135 and 141-144 that each represents a distinct or duplicate entity. Bipartite graph 110 also contains directed or undirected edges that interconnect vertices and that represent associations between entities. For demonstration, such edges are shown as undirected solid lines, although some edges may actually be directed. For example, source vertex 132 is connected by respective edges to source vertices 133-134.

Graph 110 is bipartite, which means that it consists of two subgraphs 120 and 130. As discussed below, subgraphs may or may not share data sources. For example, source subgraph 120 may receive descriptions of entities and associations from one set of data source(s), and target subgraph 130 receives descriptions of entities and associations from a disjoint different set of data source(s).

### 1.2 SIMILARITY EDGE

Computer 100 may perform initial entity resolution such as in known ways to detect that some target vertices in target subgraph 130 are potential duplicates of some source vertices in source subgraph 120. For example, computer 100 may detect that source vertex 131 and target vertex 141 each represents a person that has a same full name, which may or may not mean that vertices 131 and 141 represent a same person. When computer 100 detects that a source vertex and a target vertex are potential duplicates that potentially represent a same entity, a similarity edge that connects those two vertices is added to bipartite graph 110.

For demonstration, similarity edges are shown as directed dashed lines, although similarity edges may actually lack direction. For example, designation of subgraph 120 as source and subgraph 130 as target may or may not be somewhat arbitrary. In an embodiment, source subgraph 120 represents content that is natively managed by computer 100, such as when computer 100 is itself a data source, and target subgraph 130 represents content that is provided to computer 100 from an external data source such as a remote system. In an embodiment, source subgraph 120 represents content from a data source in one field such as government or public records, and target subgraph 130 represents content from a data source in a different field such as banking. In an embodiment, source subgraph 120 represents content computer 100 previously acquired, and target subgraph 130 represents content that is newly acquired from a same or different data source.

In any case, vertices 131 and 141 are connected by a similarity edge as shown. As explained above, similarity edges are synthetic and do not represent associations provided by data sources. In an embodiment, similarity edges are stored together with other edges such as in a same database table that stores edges. In an embodiment, similarity edges are instead stored separately from other edges such as in separate tables in a same or different database. For example, target vertex 141 has one similarity edge and one other edge that may or may not be comingled in storage.

As explained above, generation of similarity edges is based on initial entity resolution that detects potential duplicates. Because similarity is only a potentiality, a similarity edge may be more or less uncertain. Such uncertainty may be quantified such as with a numeric score such as a probability such as a percent or unit-normalized amount in a range from zero to one. Thus, initial entity resolution may assign each similarity edge a respective original amount of similarity (not shown).

A vertex may have multiple similarity edges when potentially duplicative of multiple other vertices. For example, source vertex 131 is connected to target vertices 141-142 by multiple similarity edges. Likewise, target vertex 142 is connected to source vertices 131-132 by multiple similarity edges. In various embodiments when summed together, original amounts of similarity of multiple similarity edges of a same vertex variously can or cannot exceed one or 100%. For example in an embodiment, the two similarity edges of source vertex 131 may have original amounts of similarity of 60% and 70% respectively, which together exceed 100%.

### 1.3 GRAPH STORAGE

Various embodiments may store logical objects such as entities, associations, vertices, and edges in various ways using various data structures in volatile or nonvolatile storage. In various embodiments, some or all of those kinds of logical objects may variously be stored in array(s), database table(s), or linked list(s). In various embodiments, instances of some or all of those kinds of logical objects may variously be references by an offset of an element in an array, by an offset or row identifier of a row in a database table, or by a pointer such as a memory address.

For example, a vertex or edge may contain a reference to a corresponding entity or association. Likewise, an edge may contain references to two connected vertices. In any case, some or all of those kinds of logical objects may contain additional data fields such as application-specific attributes such as a timestamp, a quantity, a code, a type, or other detail. For example, entity resolution and entity analytics may read or write fields. Accelerated entity deduplication based on similarity edges is discussed later herein.

### 2.0 EXAMPLE SIMILARITY MEASUREMENT PROCESS

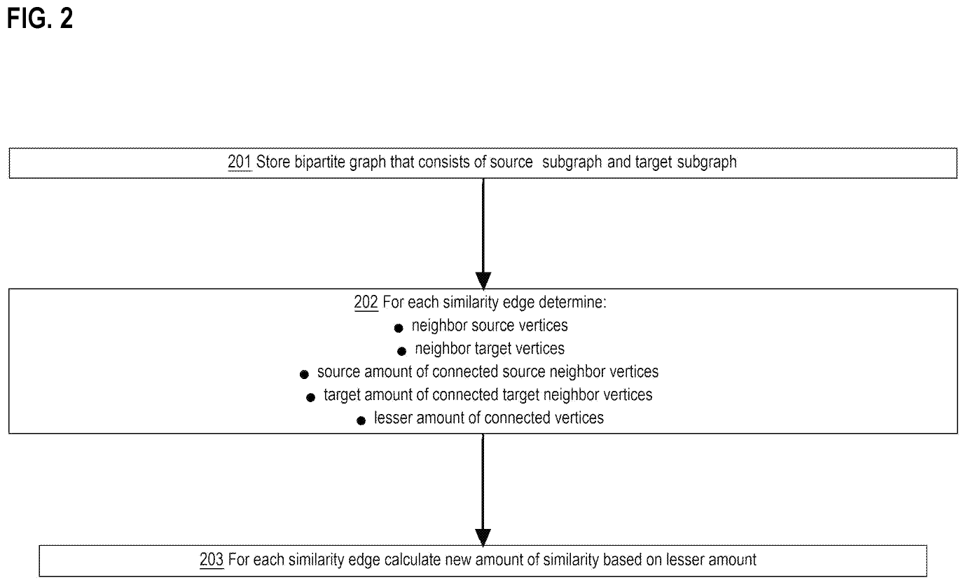

FIG. 2 is a flow diagram that depicts an example process that an embodiment of computer 100 may perform to accelerate recognizing duplicate entities based on the topology of bipartite graph 110. FIG. 2 is discussed with reference to FIG. 1.

Step 201 stores bipartite graph 110 that consists of source subgraph 120 and target subgraph 130. Step 201 includes generating and/or storing similarity edges in bipartite graph 110.

For each similarity edge in bipartite graph 110, step 202 makes various determinations as follows. As explained earlier herein, a similarity edge connects a vertex in source subgraph 120 to a vertex in target subgraph 130. Step 202 determines a neighborhood of vertices that surround each of the similarity edge's two vertices. For example as shown in FIG. 1, source vertex 132 and target vertex 142 are connected by similarity edge 173. Also as shown, source vertex 132 has neighbor source vertices 150 that includes source vertices 133-135. Likewise, target vertex 142 has neighbor target vertices 160 that includes target vertex 143.

Step 202 determines the neighborhood of a vertex as follows. All neighbor vertices in a neighborhood are connected to the vertex by a respective traversal path that is a sequence of ordinary edges. A neighborhood has a radius count of edges in those paths that connect neighbor vertices to the vertex. In an embodiment as discussed later herein, a neighborhood contains vertices that are, at most, the radius count of edges away from the vertex.

The respective radius count of edges for the source neighborhood and target neighborhood may be same or different amounts. In the shown example, both radius counts are one edge, which means that only vertices directly connected by an ordinary edge to the vertex are included in the vertex's neighborhood. For example, if the source radius count of edges were instead two, then the source neighborhood of source vertex 132 would additionally include source vertex 135 that is not directly connected to source vertex 132.

In any case, step 202 determines: a) a source amount (iii below) of source vertices in neighbor source vertices 150 that are connected to target vertices in neighbor target vertices 160, and b) a target amount (iv below) of target vertices in neighbor target vertices 160 that are connected to source vertices in neighbor source vertices 150. In various embodiments as discussed later herein, those two amounts (iii-iv) of connected vertices are counts of vertices that are or are not based on weights. For example if weights are real numbers such as coefficients, then those two amounts (iii-iv) of connected vertices are not integers.

Although based on same similarity edges 174-175, both of those amounts (iii-iv) of connected vertices for respective neighborhoods 150 and 160 may be the same or different. For example as shown those amounts (iii-iv) are different because neighbor target vertices 160 are connected to two source vertices 133-134 in neighbor source vertices 150, but neighbor source vertices 150 is connected to only one target vertex 143 in neighbor target vertices 160.

In summary for similarity edge 173, step 202 determines the following:
i. neighbor source vertices 133-135 in neighbor source vertices 150
ii. neighbor target vertex 143 in neighbor target vertices 160
iii. a source amount of two connected source neighbor vertices 133-134
iv. a target amount of one connected target neighbor vertex 143
v. lesser amount of one connected vertex that is the minimum of the source amount (iii) and the target amount (iv)

As explained earlier herein, each of similarity edges 171-176 has an original amount of similarity that may be assigned during initial entity resolution. For each similarity edge 171-176, step 203 calculates a respective new amount of similarity based on respective lesser amount (v). Mathematics and additional terms for calculating the new amounts of similarity are presented later herein.

For similarity edge 173, the new amount of similarity may be more or less than the original amount of similarity. In an embodiment, the new amount of similarity replaces the original amount of similarity. In an embodiment if the new amount of similarity falls below a removal threshold, similarity edge 173 is removed from bipartite graph 110, in which case vertices 132 and 142 are no longer considered potential duplicates of each other and are no longer candidates for merging with each other. However, none, one, or both of vertices 132 and 142 may have other similarity edges that connect to other vertices for other potential merges.

For example due to similarity edges 172-173, initially it may be unclear whether target vertex 142 represents a same entity as source vertex 131 or 132. Removal of similarity edge 173 may cause computer 100 to detect that vertices 131 and 142 represent a same entity. For example, computer 100 may decide that vertices 131 and 142 are duplicates and merge them and merge their entities to become one vertex that represents one entity, thus accomplishing deduplication. In another example, removal of similarity edge 172 may cause computer 100 to detect that: a) vertices 131 and 142 do not represent a same entity, and b) vertices 132 and 142 represent a same entity.

Likewise if amounts of similarity of similarity edges 172-173 are instead increased and both exceed a confidence threshold, then computer 100 may detect that a) source vertices 131-132, orb) vertices 131-132 and 142, represent a same entity and should be merged for deduplication. Thus, the process of FIG. 2 may cause entities to be resolved and cause bipartite graph 110 to evolve.

In an embodiment discussed later herein, the process of FIG. 2 may be iteratively repeated such that each iteration makes another analytic pass over bipartite graph 110 and further resolves entities and further adjusts bipartite graph 110. For example, the radius of both neighborhoods may be increased in each iteration.

Techniques herein provide acceleration for entity resolution in various ways, thereby accelerating the operation of computer 100 itself as an entity resolution computer. For example as explained earlier herein, subgraphs 120 and 130 may be based on content provided by different data sources. Such content retrieval may be expensive in terms of time, space, and/or money such that there may be a natural incentive to minimize how many data sources are used and/or how often content is refreshed from those data sources.

In other words, computer 100 may be intentionally designed to perform entity resolution with as few content retrievals as possible and only perform additional content retrievals from same or different data sources when previous iterations of the process of FIG. 2 achieved insufficient entity resolution. For example as discussed earlier herein, source subgraph 120 may contain old content and target subgraph 130 may contain new content. For example between process iterations, target subgraph 130 may be merged into source subgraph 120 and newly retrieved content from same or different data source(s) may be used to create a new target subgraph 130.

In an embodiment, subgraphs 120 and 130 are based on contents provided by respective sets of data sources that include additional data source(s) between process iterations. For example, source subgraph 120 may use one data source during a first iteration, two data sources during a second iteration, and so on until iteration terminates based on an entity resolution sufficiency condition.

Thus, entity resolution may be based on process iterations that consume time for communicating with data sources and time for analytic processing. The more iterations, the more time and other resources are needed. With techniques herein, computer 100 achieves a same amount of entity resolution with fewer iterations and less corroborative content from fewer data source retrievals. Thus, the performance of computer 100 itself is improved by acceleration and decreased resource consumption to achieve a same amount of entity resolution. This improved performance of computer 100 is provided by novel analytics herein based on similarity edges for faster and more confident entity resolution in a less resource intensive way.

In an embodiment, graph 110 is not bipartite, but instead is multipartite such that subgraphs 120 and 130 are not the only subgraphs of graph 110. For example, each data source may have its own subgraph in graph 110. In an embodiment, graph 110 is bipartite in a first iteration, tripartite in a second iteration, and so on until satisfying an entity resolution sufficiency condition. For example, the process of FIG. 2 may be repeated for each distinct pair of subgraphs in each iteration.

### 3.0 PSEUDOCODE OF STEP 1 OF EXAMPLE UNWEIGHTED ALGORITHM

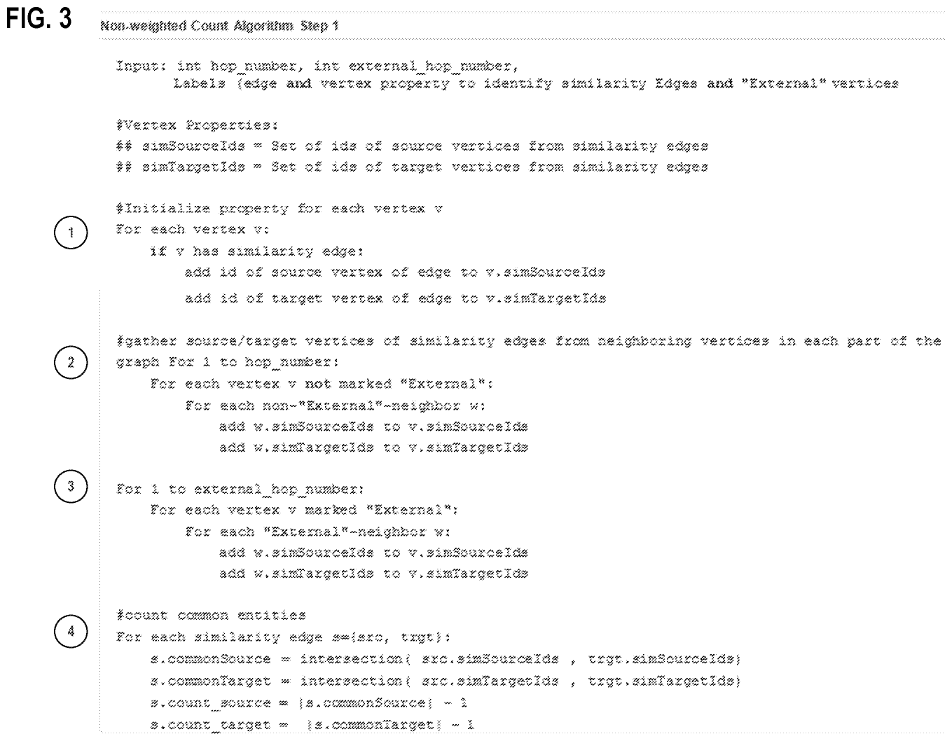

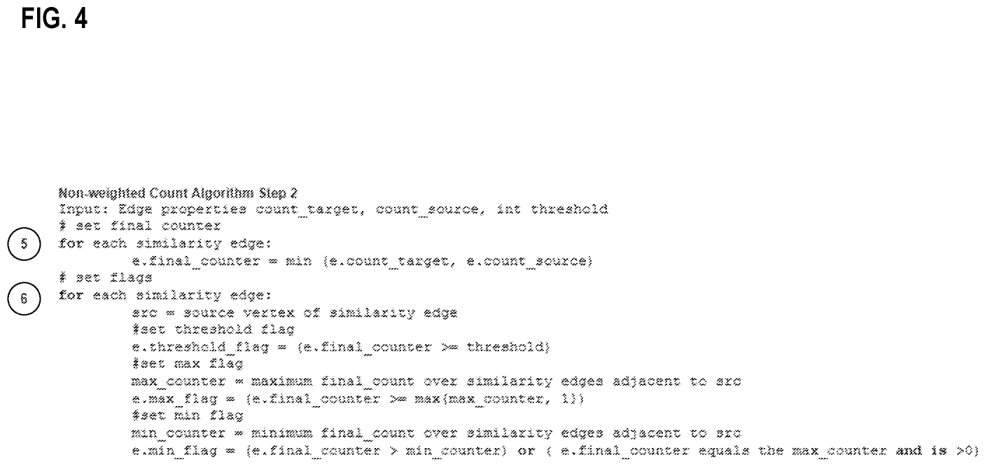

FIGS. 3-4 respectively depict pseudocode for unweighted steps 1-2 of an example unweighted neighbor counting algorithm that computer 100 may implement in an embodiment. FIGS. 3-4 are discussed with reference to FIGS. 1-2. Weight is discussed later herein.

As discussed below, portions of the pseudocode may be implementations of steps in FIG. 2. Unweighted steps 1-2 of FIGS. 3-4 include a sequence of iterative control flow loops 1-6 that operate as follows. In the pseudocode, a loop is declared with a “for” keyword such as “for each” or “for 1 to”.

As explained earlier herein, each similarity edge has two neighborhoods respectively in both subgraphs 120 and 130. Unweighted step 1 respectively counts vertices in both neighborhoods that are connected to the opposite neighborhood. For example, unweighted step 1 may be an implementation of step 202 in FIG. 2.

The following are inputs that unweighted step 1 accepts as shown.
Hop number is the maximum radius count of edges for source subgraph 120.
External hop number is the maximum radius count of edges for target subgraph 130.
Labels to identify similarity edges and vertices in target subgraph 130.

In the above inputs, the source radius and target radius may be different hop counts.

As shown, unweighted step 1 contains loops 1-4. Loops 1-3 cooperate to identify neighborhoods of vertices with similarity edges between source subgraph 120 and target subgraph 130. Loop 1 initializes the search. Loop 2: a) starts in a vertex v in source subgraph 120, b) in an increasing neighborhood, detects vertices with similarity edges between source subgraph 120 and target subgraph 130, and c) records the identifiers of such vertices. Loop 2 inspects each vertex in the source subgraph 120. Similarly, loop 3 performs the search in target subgraph 130. Loops 1-3 cooperate to detect which neighbor vertices in neighborhoods of which other vertices have similarity edges. Loop 1 detects similarity vertices, which herein are vertices that have similarity edges. Loops 2-3 cooperate to detect which neighborhoods contain which similarity vertices.

Loop 1: a) iterates over all vertices 131-136 and 141-144 of bipartite graph 110, b) discovers all similarity edges 171-176 in bipartite graph 110, and c) if there is a similarity edge connected to the vertex, each of the similarity edge's two vertices is recorded into a respective set of vertices.

Loop 2 processes one vertex at time and searches a radius-n neighborhood, with increasing n and vertices only from source subgraph 120, for vertices with similarity edges connecting subgraphs 120 and 130. When a vertex with a similarity edge is found, the identifier of the source and target vertices are recorded in respective sets of vertices.

Loop 3 has the same pattern as Loop 2. A difference is that loop 3 iterates over vertices and searches for neighbors from target subgraph 130. The effect of loops 2-3 is that each processed vertex contains a set of vertices in the neighborhood connected to similarity edges.

A counterintuitive effect of merging expanding neighborhoods is that the horizon of merged information may be a distance from current vertex v that exceeds the current radius count of edges. That is because the horizon distance may be twice the radius count of edges because two neighborhoods participate in one merge. For example when the radius count of edges is two, vertices v and w in loop 2 may be separated by a path of two edges, and w may be separated from a similarity vertex in vertex w's neighborhood by another path of two edges, which means that a path from vertex v to the similarity vertex may instead be a concatenated path of 2+2=four edges. Thus, the horizon of merged information for a neighborhood expands faster than the neighborhood itself expands, which is counterintuitive.

An optimization in loops 1-3 avoids tracking which vertices are in which expanding neighborhoods. Instead, only which similarity vertices are in which neighborhoods is tracked by maps simSourceIds and simTargetIds. However every vertex, having a similarity edge or not, has its own neighborhood, which is why loop 2 says “for each vertex v”.

Thus, merging (i.e. union) neighborhoods entails only merging sets of similarity vertices. Loop 2 says “add” that merges the identifiers of the similarity vertices of neighborhoods of vertices that are in the neighborhood of a current vertex. Loop 2 is an outer loop that is repeated to increment the radius count of edges, which causes neighborhoods to iteratively expand.

Although, only vertices with similarity edges contribute to simSourceIds and simTargetIds, the remaining vertices within source graph 120 still: a) track which similarity vertices are in the vertex's expanding neighborhood and b) propagate the information of (a) to other vertices within source graph 120. For example, a first vertex that has a similarity edge and a third vertex may be separated by a second vertex that lacks a similarity edge such that the first vertex and the third vertex both are immediately adjacent to the second vertex, but the first vertex and the third vertex are not immediately adjacent to each other.

In a first iteration of loop 2, merging of neighborhoods of the first vertex and the second vertex causes accounting of the similarity edge to be propagated to the second vertex. In a second iteration of loop 2, merging of neighborhoods of the second vertex and the third vertex causes accounting of the similarity edge to be propagated to the third vertex. Thus, the first vertex and the third vertex may eventually account each other's similarity edges even though the first vertex and the third vertex are not immediately adjacent, and even though knowledge of the existence of the similarity edge must propagate through the second vertex that has no similarity edge. Thus, accounting of similarity edges may transitively propagate through portions of source subgraph 120, including to and from vertices that lack similarity edges.

Although loop 2 is coalescing neighborhoods of source subgraph 120, loop 2 is not traversing subgraph 120, because neighborhood expansion by coalescing does not entail subgraph traversal, which necessarily would require traversal paths. Graph traversal with paths is stateful, because a path records a sequence of previous states. Whereas techniques herein are not stateful and do not record visiting some vertices before other vertices. That is because all vertices have their own neighborhoods that are simultaneously expanding to merge with each other. Information propagates by merging neighborhoods, which is stateless, and not by traversing stateful paths. For example, when an identifier of a similarity vertex is propagated from neighborhood information of one vertex into a neighborhood information of another vertex, there is no record of a traversal path that could reach the similarity vertex.

Loops 2-3 say “For 1 to hop number” that does not declare an iteration counter variable. In other words and counterintuitively, the operation of each iteration of loop 2 or 3 is the same without regard for which is the current iteration, which is more or less stateless. Thus, computer 100 need not generate graph traversal paths. Thus, neither loops 2-3 nor any of FIGS. 3-4 performs a breadth first search (BFS) nor a depth first search (DFS).

Loop 4 iterates over all similarity edges 171-176 in bipartite graph 110. Each similarity edge has a source vertex and a target vertex and, thus, two neighborhoods. Per step 202 of FIG. 2, only neighboring vertices that have a similarity edge that connects both neighborhoods should be counted, which is why loop 4 says “intersection”.

### 4.0 PSEUDOCODE OF STEP 2 OF EXAMPLE UNWEIGHTED ALGORITHM

Unweighted step 2 in FIG. 4 calculates statistics based on counts generated by unweighted step 1. Unweighted step 2 includes loops 5-6. Loop 4 already respectively counted similarity vertices in each of two neighborhoods. Loop 5 measures a similarity score, or an increment to a previous similarity score, for a similarity edge by detecting the lesser of both counts, which is why loop 5 says “min”.

As explained earlier herein, source subgraph 120 may be an application's internal or native graph, and target subgraph 130 may be provided by an external data source for corroboration and/or enrichment of subgraph 120. For example in an embodiment, target subgraph 130 may be temporally useful as a basis for updating source subgraph 120 after which target subgraph 130 may be discarded such as after merging target vertices into respective similar source vertices based on similarity scores of similarity edges. Thus over a longer term, only source subgraph 130 is retained, and some statistics need only be calculated for source vertices and not target vertices. Thus, loop 6 says “source vertex” but does not refer to a target vertex.

Loop 6 calculates statistics that may be used as discussed later herein. Loop 6 also detects duplicate vertices as needed for entity resolution and deduplication. If the similarity score exceeds a confidence threshold, then loop 6 marks the similarity edge as connecting two duplicate vertices, which is why loop 6 says “threshold flag”.

### 5.0 EXAMPLE UNWEIGHTED DATAFLOW

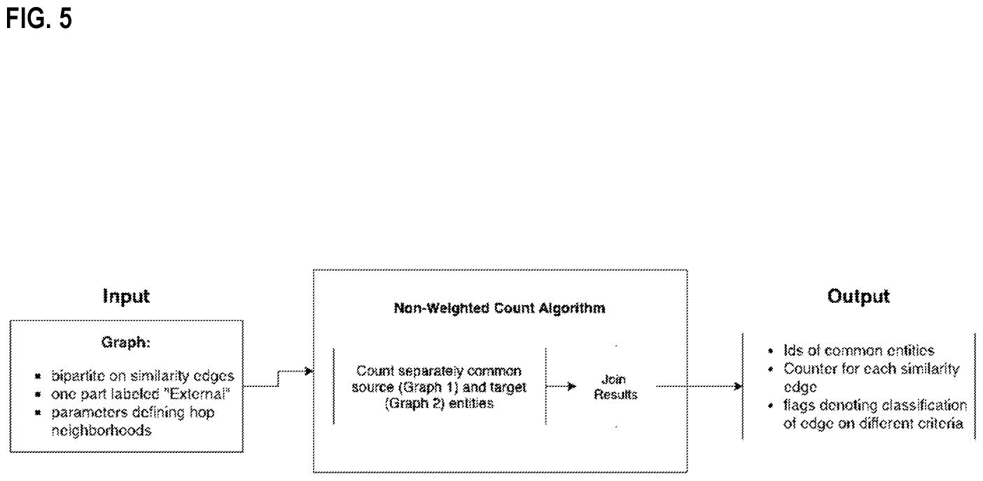

FIG. 5 is a dataflow diagram that depicts example inputs, outputs, and intermediate data for the example unweighted neighbor counting algorithm in FIGS. 3-4, in an embodiment. FIG. 5 is discussed with reference to FIG. 1.

As shown in FIG. 5, the input contains bipartite graph 110, including similarity edges 171-176 and express subgraphs 120 and 130. The input also contains a respective maximum neighborhood radius for both subgraphs 120 and 130.

Shown inside the example unweighted neighbor counting algorithm in FIG. 5 are left and right sides that respectively are unweighted steps 1-2 of respective FIGS. 3-4. The output shown in FIG. 5 contains a vertical sequence of three bullet items that are the result of unweighted step 2. The top bullet is the result of loop 4. The middle bullet is the result of loop 5. The bottom bullet is the result of loop 6.

### 6.0 EXAMPLE SIMILARITY ADJUSTMENT

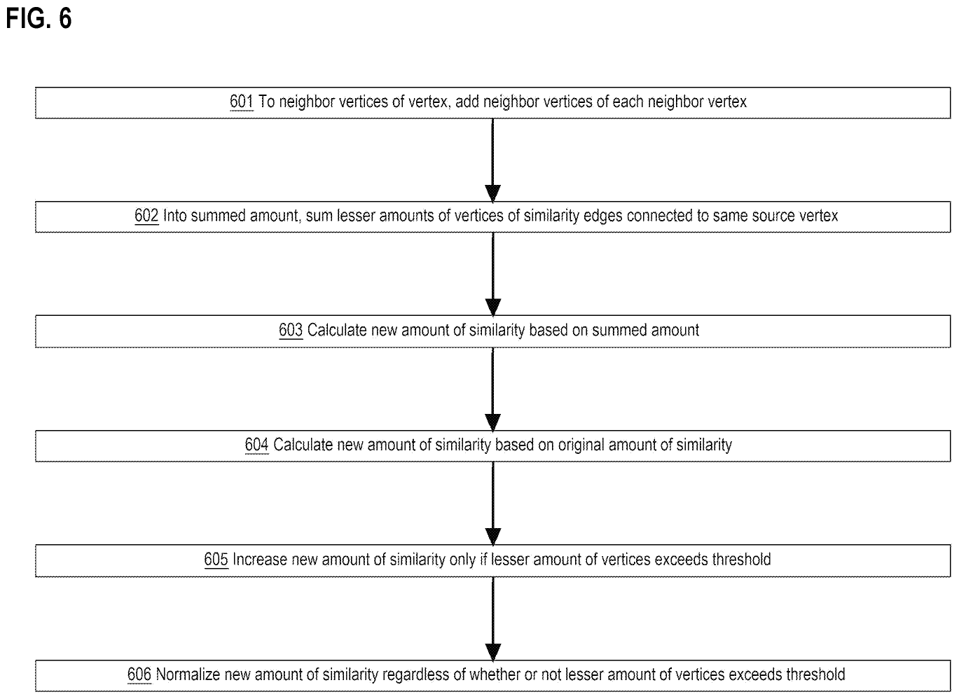

FIG. 6 is a flow diagram that depicts an example process that an embodiment of computer 100 may perform to adjust amounts of similarity of similarity edges 171-176. FIG. 6 is discussed with reference to FIGS. 1 and 3-4.

Each time the radius count of edges is incremented to expand neighborhoods, step 601 is repeated for each similarity vertex in each of subgraphs 120 and 130. To neighbor vertices of a given vertex, step 601 adds neighbor vertices of each neighbor vertex. In an embodiment, step 601 is implemented as loops 2-3 of FIG. 3 respectively for subgraphs 120 and 130.

As explained earlier herein, loop 5 measures an increment to an existing similarity score for a similarity edge. Because the increment is always non-negative, the increment always causes a new similarity score to be greater than or equal to the previous similarity score of the similarity edge. In other words, the calculation is biased toward monotonically increasing scores, which may be somewhat unrealistic. Thus, score normalization may be beneficial to keep scores in a predefined range such as a probability from zero to one or a percentage from zero to a hundred. Step 602 normalizes similarity scores as follows.

As explained earlier herein, target subgraph 130 may be temporally useful as a basis for updating source subgraph 120 after which target subgraph 130 may be discarded such as after merging target vertices into respective similar source vertices based on similarity scores of similarity edges in an embodiment. Thus over a longer term, only source subgraph 120 is retained, and some statistics need only be calculated based on source vertices and not target vertices. As follows, normalization of similarity scores may be based on source vertices and not target vertices.

As explained earlier herein, the score increment calculated by loop 5 is the lesser of a source count and a target count for a similarity edge. Step 602 is repeated for each source vertex that has a similarity edge. Into a summed amount, step 602 sums lesser amounts of vertices of each similarity edge that is connected to the source vertex. In other words, step 602 sums the score increments of all similarity edges of a same source vertex. For example, similarity edges 171-172 are connected to same source vertex 131.

For each similarity edge of that same source vertex, step 603 calculates a new amount of similarity based on the summed amount that was accumulated by step 602. For example, the score increment may be based on the summed amount. For example, the score increment may be normalized by the summed amount. In an embodiment, a normalized increment is a ratio of the raw increment of step 602 divided by the summed amount. In that way, the normalized increment may be unit normalized into a unit range from zero to one or a percent range from zero to a hundred.

Step 604 calculates a new amount of similarity based on an original (i.e. previous) amount of similarity. For example, the new score may be the sum of the old score and the score increment. For example, if the old score is 95%, and the normalized increment is 10%, then the new score is 95+10=105%, which may be somewhat unrealistic. New scores may be (e.g. further) normalized as a ratio of new score divided by a highest new score of all similarity edges connected to that same source vertex.

For example, if the new score of a similarity edge is 105% but the highest new score in the graph is 150%, then the finally normalized new score of the similarity vertex is 105/150=70%. In other words, even though the score increment is never negative, a similarity score may decrease due to normalization. In an embodiment, the old score is retained if the new score would decrease. In other words, only new scores that actually increase are accepted.

As explained earlier herein, the score increment calculated by loop 5 is the lesser of a source count and a target count for a similarity edge. In an embodiment, the score increment is set to zero if the score increment does not exceed an increment threshold. In other words, step 605 increases the new amount of similarity only if the lesser amount of vertices exceeds the increment threshold.

Step 606 normalizes the new amount of similarity regardless of whether or not the lesser amount of vertices exceeds the increment threshold. For example as explained above for step 604, normalization may cause the new amount of similarity for a similarity edge to be less than the original amount of similarity. Thus, similarity scores of some similarity edges may increase while others in a same graph may decrease.

### 7.0 PSEUDOCODE OF STEP 1 OF EXAMPLE WEIGHTED ALGORITHM

The unweighted neighbor counting algorithm in FIGS. 3-4 treats all vertices as equal, which means that the unweighted neighbor counting algorithm may ignore semantics of bipartite graph 110 that are not shown in FIG. 1. A software application may have semantics such that vertices individually have respective weight so that some vertices have more impact on entity resolution than others.

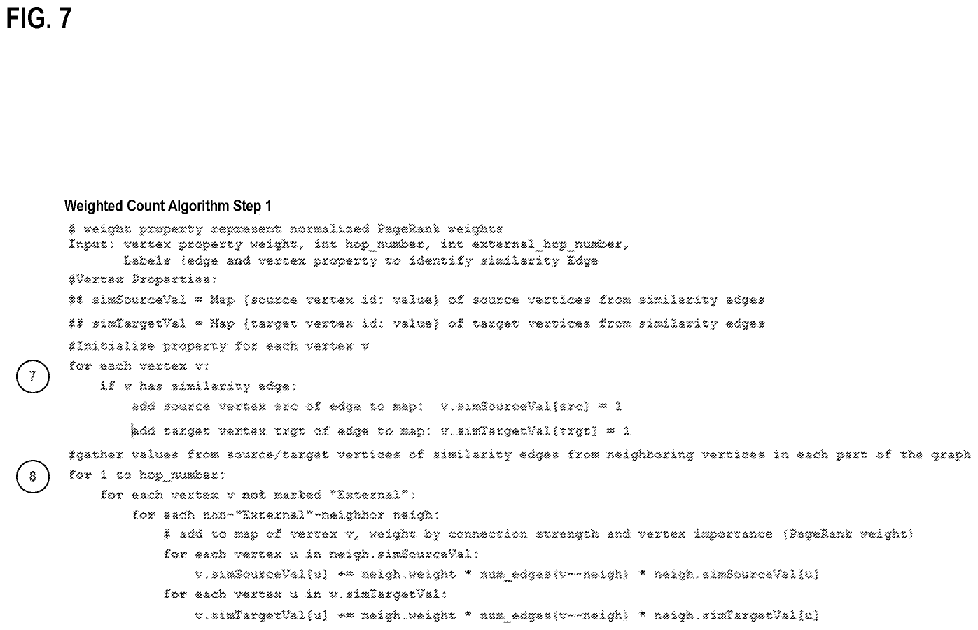

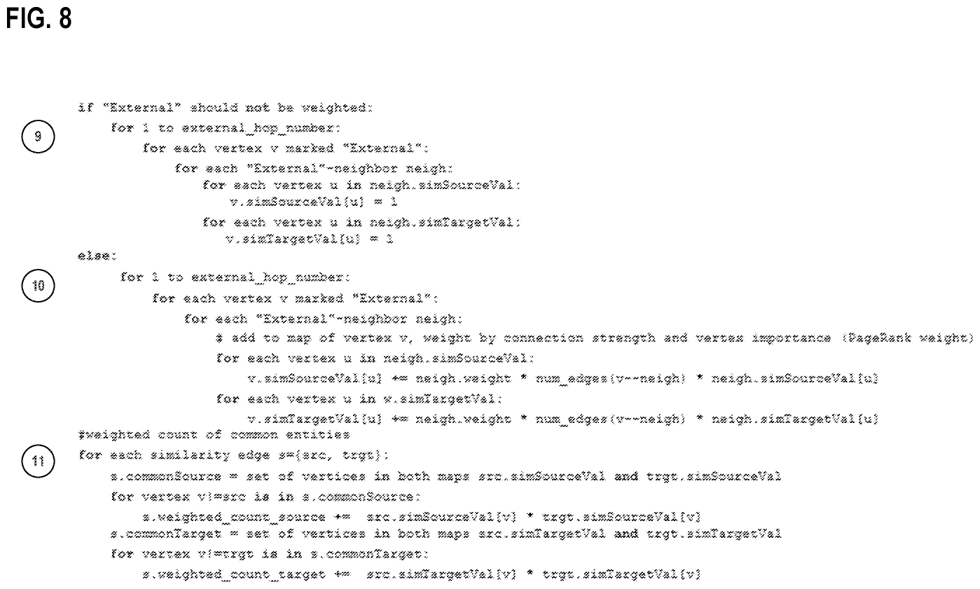

FIGS. 7-9 depict pseudocode for weighted steps 1-2 that are respective replacements for unweighted steps 1-2 of FIGS. 3-4. FIGS. 7-8 depict respective halves of weighted step 1. Vertex weights for weighted step 1 are provided by a software application. In weighted step 1, vertex weights are used to calculate connection weights. A vertex weight is different from a connection weight as follows.

Each vertex has its own vertex weight, regardless of whether or not the vertex has a similarity edge. Thus, there is a one-to-one correspondence between a vertex weight and a vertex, which is a graph element. There is no one-to-one correspondence between a connection weight and a graph element, such as a vertex or an edge. Each vertex has as many connection weights as similarity vertices in the neighborhood of the vertex.

Vertex weight represent how important a vertex is for measuring similarity of two vertices. The intuition behind vertex weight is that the more connected by ordinary edges those vertices are to other vertices, the less important those vertices are for measuring similarity, while the less connected vertices are, the more important those vertices are for similarity. The reason is that an account with many connections means very little for any two vertices connected to the account. A real world example may be an utility company's account receiving monthly payments from many customers. The fact that two entities are connected via this account means very little other than they are customers of the same company and maybe are located in the same sales region. Conversely, if two entities are connected through an account that transacts only with those two entities, that is strong signal that the two entities have close ties.

Connection weights are counter intuitive because they regard vertices that are connected by ordinary edges, whereas similarity scoring instead involves similarity edges that are not ordinary edges. Connection weights are novel for two reasons. First, state of the art entity resolution did not involve ordinary edges nor an expanding neighborhood of a vertex. Second, connection weights are computed (i.e. derived) and based on subgraph topology instead of being provided by application semantics. For example, techniques herein may post process results of a known entity resolution approach as explained earlier herein, and connection weights may be calculated after the known approach finishes. Indeed, the known entity resolution approach may be unaware of vertex weights and connection weights.

As shown, weighted step 1 accepts an additional input, vertex property weight, that is the respective numeric vertex weight of each vertex and may be read only. As shown, weighted step 1 also accepts all of the inputs that unweighted step 1 accepts as explained earlier herein.

Each vertex has an immutable vertex weight that is provided as input. Vertex weight has application specific semantics that connote importance. For example, PageRank is a known algorithm that discovers vertex weights of vertices. In a classic PageRank embodiment, each vertex represents a hypertext markup language (HTML) webpage and each ordinary edge represents a hyperlink in a source webpage that references a target webpage.

Each vertex also has a respective connection weight for each similarity vertex in the expanding neighborhood of the vertex that weighted step 1 iteratively calculates by accumulation as discussed later herein. Different vertices may have different respective counts of connection weights because vertices may have different respective counts of similarity vertices within their respective neighborhoods, and those respective counts may or may not increase as the neighborhoods expand.

In an embodiment, each vertex has an aggregation, such as an associative array or other map, of connection weights. For example, a connection weight map of a vertex may operate as a lookup table that accepts a similarity vertex as a lookup key and returns a respective connection weight between the vertex and the similarity vertex.

Connection weights occur in pairs because connection weights represent influence by two vertices upon each other. However, connection weights are not symmetric because different vertices have different vertex weights and, although two vertices are involved, only the vertex weight of the opposite vertex u contributes to the connection weight for the current vertex v as loop 8 shows. Thus, a pair of vertex weights may have different values.

Connection weights are iteratively revised as loop 8 iterates. As neighborhoods expand, more vertices share their information with each other, which may have some counterintuitive effects. For example, a vertex with a high vertex weight may inflate the connection weight in the connection weight arrays of opposite vertices. However due to transitive propagation of neighborhood information through multiple vertices, the value of a given connection weight may be more a result of distant vertices than near vertices, depending on the subgraph topology.

A counterbalancing influence is that loop 8 increases the impact of near vertices by accounting for them in more iterations. For example, the vertex weight of a vertex u that is included into the neighborhood of a given vertex v only in the last iteration is directly used only once to calculate a given connection weight. Whereas, the vertex weight of a different vertex u that is immediately adjacent to the given vertex is directly and repeatedly used the most times for calculating the given connection weight. That is because a vertex does not directly contribute vertex weight for a given neighborhood until the vertex is included into the expanding neighborhood but, once included in the neighborhood, the vertex weight of the vertex is directly used in each subsequent iteration. Thus, different vertices directly contribute weight in different respective counts of iterations for a same neighborhood. Likewise, a same vertex directly contribute weight in different respective counts of iterations for different neighborhoods.

In any case, all connection weights are initially zero. Weighted step 1 includes loops 7-11. Even though unweighted step 1 of FIG. 3 has separate respective loops for subgraphs 120 and 130, those separate loops were similar so that subgraphs 120 and 130 are processed in a same way. Weighted step 1 instead may conditionally process target subgraph 130 as weighted or unweighted, which makes explanation of the loops of weighted step 1 more involved as follows.

Loops 7-8 process source subgraph 120. Loop 7 detects pairs of vertices connected by a same similarity edge and sets the connection weights for the ordinary edges of those two vertices to one. Thus initially, only vertices that have a similarity edge have non-zero connection weights. As explained earlier herein, by iteratively expanding a radius of a neighborhood of vertices that surround a vertex that has a similarity edge, entity similarity and relationship information transitively propagates throughout the neighborhood. Thus, connection weights may eventually become non-zero for vertices that lack a similarity edge, such as iteratively as follows.

Loop 8 processes vertices, not similarity edges. Loop 8 has four vertex variables as follows. Vertex v is each vertex in source subgraph 120. Vertex neigh is each vertex in the expanding neighborhood of vertex v, which is each source vertex that is connected to vertex v by a sufficient count of ordinary edges, which depends on the current radius of the expanding neighborhood. Vertex u has two phases (i.e. loops). In the first phase, vertex u is all of the source vertices in the expanding source neighborhood of vertex neigh. In the second phase, vertex u instead is all of the target vertices in the expanding target neighborhood of the similarity edge of vertex neigh.

Transitive propagation of accounting of similarity edges to, from, and through vertices that lack similarity edges occurs in a way that is more or less the same as explained earlier herein for loop 2. For example in both loops 2 and 8, a vertex that initially accounts for no similarity edges may eventually receive such information from other vertices. For example, loop 8's simSourceVal of a vertex may be an initially empty associative array (i.e. map) but, after iteration(s), may accumulate similarity vertex identifiers and connection weights based on similarity edges that eventually are included into the expanding neighborhood of the vertex.

Both of the weighted and unweighted neighbor counting algorithms coalesce smaller neighborhoods to generate bigger neighborhoods. As explained earlier herein, the unweighted neighbor counting algorithm merges neighborhoods by merging sets of vertices. Loop 8 of the weighted neighbor counting algorithm instead merges neighborhoods by monotonically increasing respective connection weights in connection weight arrays by iterative accumulation.

Although not shown in FIG. 1, the unweighted neighbor counting algorithm ignores redundant edges when multiple ordinary edges connect a same two vertices. Accumulation is why loop 8 says “+=” that iteratively sums multiplicative products, which is why loop 8 says “*”. Given a vertex neigh that is in the expanding neighborhood of the current vertex v, the multiplicative product in any iteration multiplies: a) the vertex weight of vertex neigh times b) a count of redundant edges (which is why loop 8 says “num_edges”) that connect the current vertex to vertex neigh times c) the connection weight of the current vertex in the connection weight array of vertex neigh. In that way, loop 8 uses iterative summation to monotonically increase the connection weight of vertex neigh in the connection weight array of the current vertex.

Weighted step 1 instead may conditionally process target subgraph 130 as weighted as discussed above or unweighted as discussed earlier herein. Loop 9 processes target subgraph 130 as unweighted. For example as discussed earlier herein, target subgraph 130 may represent data retrieved from a separate data source that lacks weights. Loop 10 instead processes target subgraph 130 as weighted.

As explained earlier herein, each similarity edge connects two vertices and thus has two neighborhoods. Loop 11 detects which vertices in either neighborhood is connected by the same or other similarity edge to the other neighborhood, which is why loop 11 says “commonSource” and “commonTarget”.

As explained above, loops 8 and 10 calculate values in connection weight arrays. Loop 11 integrates connection weights to measure a similarity score of a similarity edge. Loop 11 measures a similarity score by summing multiplicative products. For a given vertex of the similarity edge and a given common vertex (i.e. in commonSource or commonTarget), the multiplicative product is: a) the value for the common vertex in the connection weight array of the similarity vertex times b) the value for the common vertex in the connection weight array of the other vertex of the similarity edge.

### 8.0 PSEUDOCODE OF STEP 2 OF EXAMPLE WEIGHTED ALGORITHM

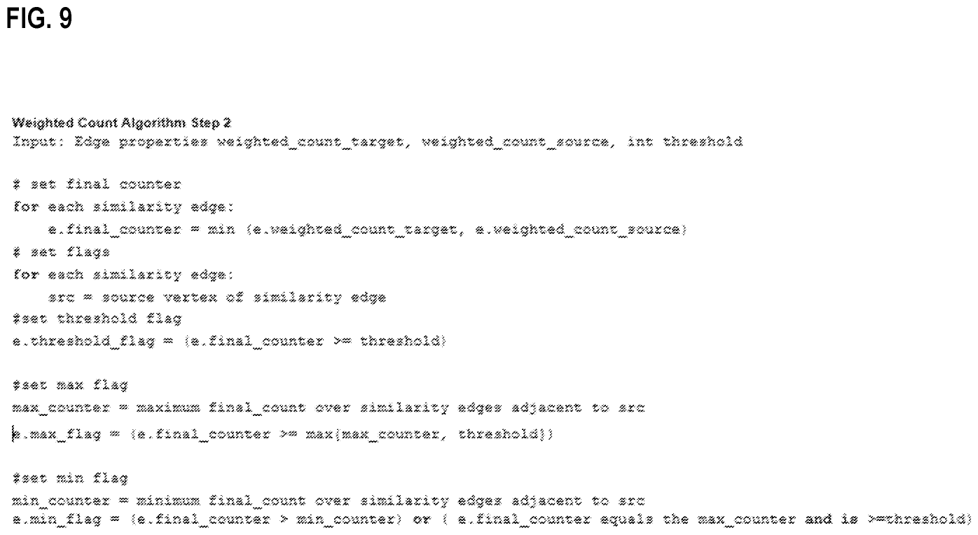

FIG. 9 depicts pseudocode for weighted step 2 that operates in substantially the same way as unweighted step 2 as discussed earlier herein.

9.0 EXAMPLE WEIGHTED DATAFLOW

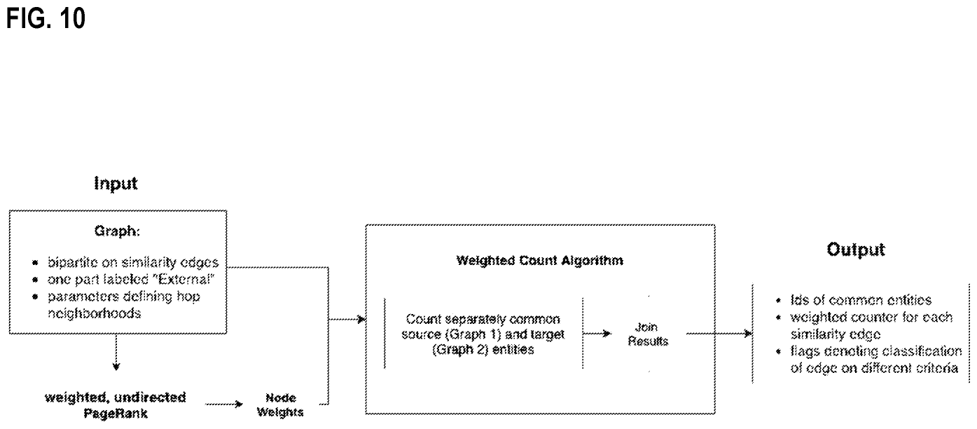

FIG. 10 is a dataflow diagram that depicts an example inputs, outputs, and intermediate data for the example weighted neighbor counting algorithm in FIGS. 6-8, in an embodiment. FIG. 10 is discussed with reference to FIG. 1.

As shown in FIG. 10, the inputs are the same as discussed for unweighted FIG. 5. As shown, vertex weights are measured by PageRank as discussed earlier herein. Shown inside the example weighted neighbor counting algorithm in FIG. 10 are details that are the same as discussed for unweighted FIG. 5. The outputs shown in FIG. 10 are the same as discussed for unweighted FIG. 5, except that the similarity score for each similarity edge is a weighted real number measurement instead of an unweighted integer count.

### 10.0 EXAMPLE WEIGHTED SIMILARITY ADJUSTMENT

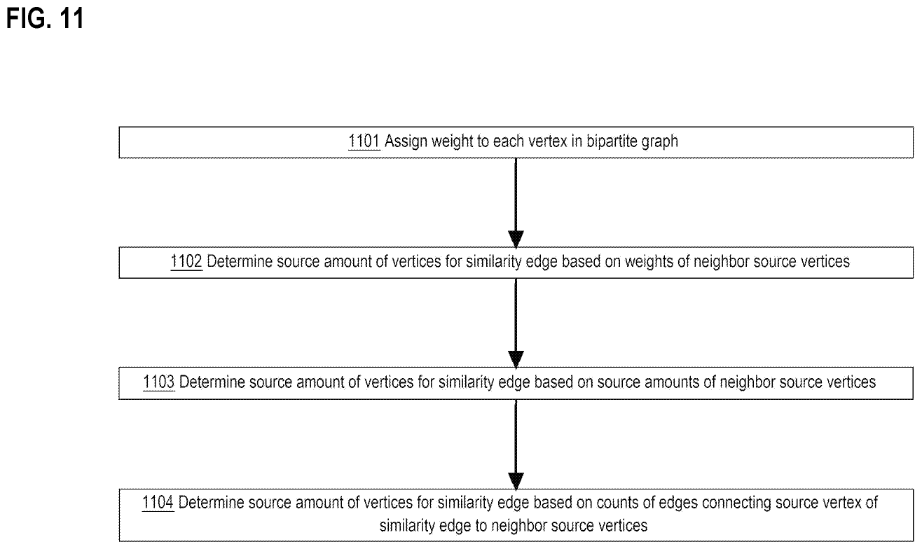

FIG. 11 is a flow diagram that depicts an example process that an embodiment of computer 100 may perform to adjust amounts of similarity of similarity edges 171-176 based on vertex weights and connection weights of vertices in bipartite graph 110. FIG. 11 is discussed with reference to FIGS. 1 and 6-8.

As a preface to weighted step 1, step 1101 assigns a respective vertex weight to each vertex in bipartite graph 110. For example as discussed elsewhere herein, a weight assignment algorithm such as PageRank may be used for step 1101.

For each similarity edge, step 1102 determines a respective source amount of vertices for a similarity edge based on weights of vertices in neighbor source vertices. Due to weighting arithmetic, the source amount of vertices need not be an integer. In other words and unlike the unweighted algorithm, the source amount of vertices is not a count of vertices. Loop 8 may be an implementation of step 1102.

Similar to as explained earlier herein for unweighted loops 2-3, loops 8-10 say “for 1 to hop number” without declaring an iteration counter. Thus, loops 8-10 may operate without regard for which is the current iteration number.

As explained earlier herein, weighted step 1 processes source subgraph 120 and may or may not conditionally process target subgraph 130 as weighted or unweighted. For example, weighted step 1 may process both subgraphs 120 and 130 as weighted. In that case, step 1102 that calculates a source amount of vertices based on neighbor source vertices may be accompanied by a similar step that calculates target amounts of vertices based on vertices in neighbor target source vertices, which may be implemented as loop 10.

As explained above, loops 8 and 10 calculate values in connection weight arrays based on more or less complicated arithmetic that entails summation and weighting coefficients. For example, step 1102 that performs loop 8 may entail steps 1103-1104 as sub-steps that cooperate to calculate a same connection weight.

Step 1103 determines the source amount of vertices for a similarity edge based on source amounts of vertices in neighbor source vertices. As explained earlier herein, loop 8 of the weighted neighbor counting algorithm merges neighborhoods by monotonically increasing respective connection weights in connection weight arrays by iterative accumulation. Loop 8 may be an implementation of step 1103.

As explained earlier herein, loop 8 uses iterative summation to monotonically increase the connection weight of a vertex in the connection weight array of the current vertex, which is based on a count of redundant edges that connect the current vertex to the vertex. Step 1104 determines the source amount of vertices for a similarity edge based on respective counts of redundant edges connecting the source vertex of the similarity edge to neighbor source vertices. Redundant edges are explained earlier herein. Loop 8 may be an implementation of step 1104.

### 11.0 EXAMPLE PAGERANK PROCESS

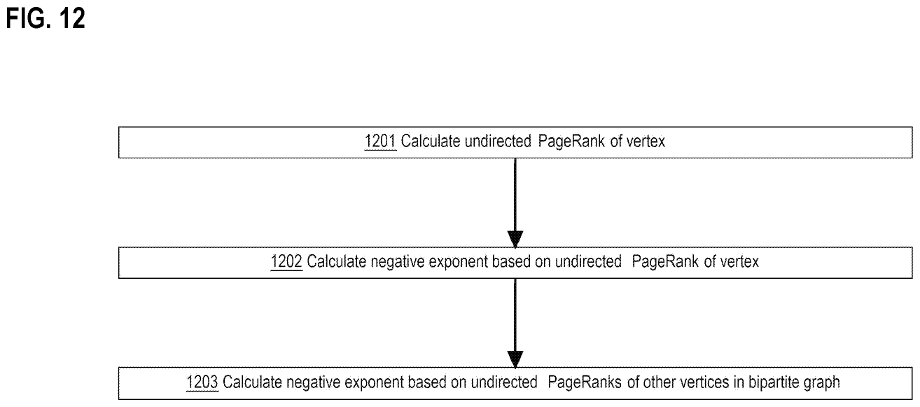

FIG. 12 is a flow diagram that depicts an example PageRank process that an embodiment of computer 100 may perform to measure the vertex weight of a vertex. FIG. 12 is discussed with reference to FIGS. 1 and 11.

Steps 1201-1203 may cooperate to measure the vertex weight of a vertex. In an embodiment, steps 1201-1203 are sub-steps of step 1101 of FIG. 11.

As explained earlier herein, classic PageRank uses an ordinary edge to represent a hyperlink. Hyperlinks are naturally directed such that two webpages cross referencing each other needs two hyperlinks, which is one in each of both directions. Step 1201 calculates an undirected PageRank of a vertex. Thus, edge direction is ignored, and an ordinary edge may increase the vertex weights of both vertices that the edge interconnects, although not necessarily by a same amount of increase. Whereas with classic directed PageRank, an edge would only contribute to the vertex weight of one vertex.

Steps 1202-1203 may cooperate to calculate an vertex weight of a vertex by normalizing an undirected PageRank of the vertex that was calculated by step 1201. Step 1202 calculates the vertex weight as a negative exponent that is based on the undirected PageRank of the vertex such as e⁻ⁿ, where e is Euler's natural number and n is based on the undirected PageRank of the vertex.

Step 1203 calculates the vertex weight as a negative exponent based on undirected PageRanks of other vertices in bipartite graph 110 such as e⁻ⁿ where n is the ratio of the undirected PageRank of the vertex divided by the average undirected PageRank of all vertices in the graph. Thus, zero is a lower bound on the vertex weight of the vertex as calculated by step 1203 if the undirected PageRank of the vertex approaches zero. Likewise, a vertex whose undirected PageRank coincidentally is the same as the average undirected PageRank should have an vertex weight of 1/e. The vertex weight of a vertex need not have an upper bound because PageRank does not have an upper bound. The reason for a negative exponent transformation of the undirected PageRank value is as explained earlier herein. For example, the PageRank value is higher for more connected vertices, but the significance of such vertices for similarity may be very low. In contrast the less connected vertices, with low PageRank value, may be very important for measuring similarity.

### HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

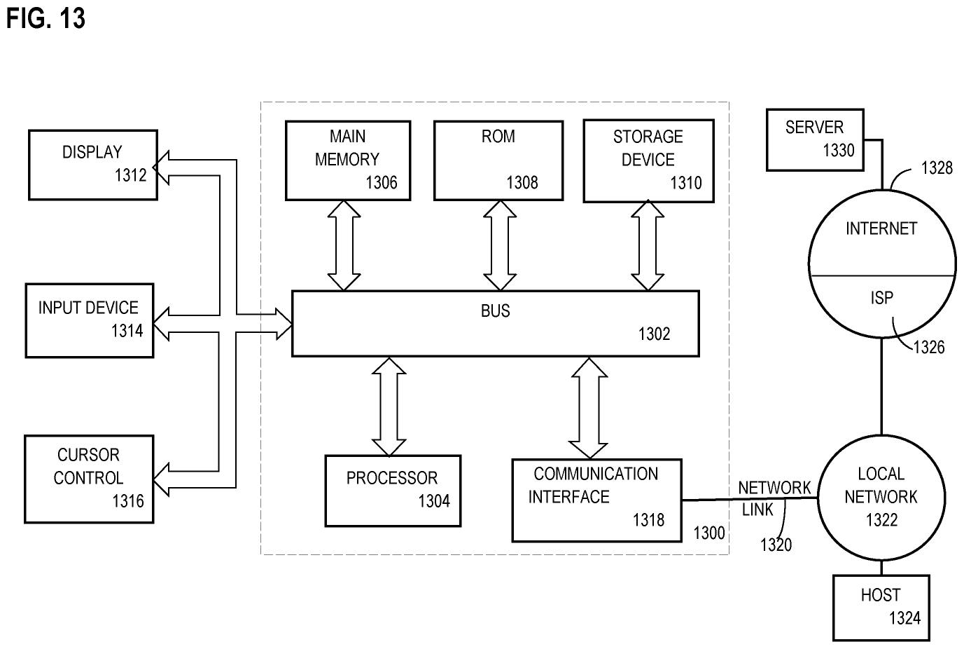

For example, FIG. 13 is a block diagram that illustrates a computer system 1300 upon which an embodiment of the invention may be implemented. Computer system 1300 includes a bus 1302 or other communication mechanism for communicating information, and a hardware processor 1304 coupled with bus 1302 for processing information. Hardware processor 1304 may be, for example, a general purpose microprocessor.

Computer system 1300 also includes a main memory 1306, such as a random access memory (RAM) or other dynamic storage device, coupled to bus 1302 for storing information and instructions to be executed by processor 1304. Main memory 1306 also may be used for storing temporary variables or other intermediate information during execution of instructions to be executed by processor 1304. Such instructions, when stored in non-transitory storage media accessible to processor 1304, render computer system 1300 into a special-purpose machine that is customized to perform the operations specified in the instructions.

Computer system 1300 further includes a read only memory (ROM) 1308 or other static storage device coupled to bus 1302 for storing static information and instructions for processor 1304. A storage device 1310, such as a magnetic disk, optical disk, or solid-state drive is provided and coupled to bus 1302 for storing information and instructions.

Computer system 1300 may be coupled via bus 1302 to a display 1312, such as a cathode ray tube (CRT), for displaying information to a computer user. An input device 1314, including alphanumeric and other keys, is coupled to bus 1302 for communicating information and command selections to processor 1304. Another type of user input device is cursor control 1316, such as a mouse, a trackball, or cursor direction keys for communicating direction information and command selections to processor 1304 and for controlling cursor movement on display 1312. This input device typically has two degrees of freedom in two axes, a first axis (e.g., x) and a second axis (e.g., y), that allows the device to specify positions in a plane.

Computer system 1300 may implement the techniques described herein using customized hard-wired logic, one or more ASICs or FPGAs, firmware and/or program logic which in combination with the computer system causes or programs computer system 1300 to be a special-purpose machine. According to one embodiment, the techniques herein are performed by computer system 1300 in response to processor 1304 executing one or more sequences of one or more instructions contained in main memory 1306. Such instructions may be read into main memory 1306 from another storage medium, such as storage device 1310. Execution of the sequences of instructions contained in main memory 1306 causes processor 1304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1310. Volatile media includes dynamic memory, such as main memory 1306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1302. Transmission media can also take the form of acoustic or light waves, such as those generated during radio-wave and infra-red data communications.

Various forms of media may be involved in carrying one or more sequences of one or more instructions to processor 1304 for execution. For example, the instructions may initially be carried on a magnetic disk or solid-state drive of a remote computer. The remote computer can load the instructions into its dynamic memory and send the instructions over a telephone line using a modem. A modem local to computer system 1300 can receive the data on the telephone line and use an infra-red transmitter to convert the data to an infra-red signal. An infra-red detector can receive the data carried in the infra-red signal and appropriate circuitry can place the data on bus 1302. Bus 1302 carries the data to main memory 1306, from which processor 1304 retrieves and executes the instructions. The instructions received by main memory 1306 may optionally be stored on storage device 1310 either before or after execution by processor 1304.

Computer system 1300 also includes a communication interface 1318 coupled to bus 1302. Communication interface 1318 provides a two-way data communication coupling to a network link 1320 that is connected to a local network 1322. For example, communication interface 1318 may be an integrated services digital network (ISDN) card, cable modem, satellite modem, or a modem to provide a data communication connection to a corresponding type of telephone line. As another example, communication interface 1318 may be a local area network (LAN) card to provide a data communication connection to a compatible LAN. Wireless links may also be implemented. In any such implementation, communication interface 1318 sends and receives electrical, electromagnetic or optical signals that carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communication services through the world wide packet data communication network now commonly referred to as the “Internet” 1328. Local network 1322 and Internet 1328 both use electrical, electromagnetic or optical signals that carry digital data streams. The signals through the various networks and the signals on network link 1320 and through communication interface 1318, which carry the digital data to and from computer system 1300, are example forms of transmission media.

Computer system 1300 can send messages and receive data, including program code, through the network(s), network link 1320 and communication interface 1318. In the Internet example, a server 1330 might transmit a requested code for an application program through Internet 1328, ISP 1326, local network 1322 and communication interface 1318.

The received code may be executed by processor 1304 as it is received, and/or stored in storage device 1310, or other non-volatile storage for later execution.

### SOFTWARE OVERVIEW

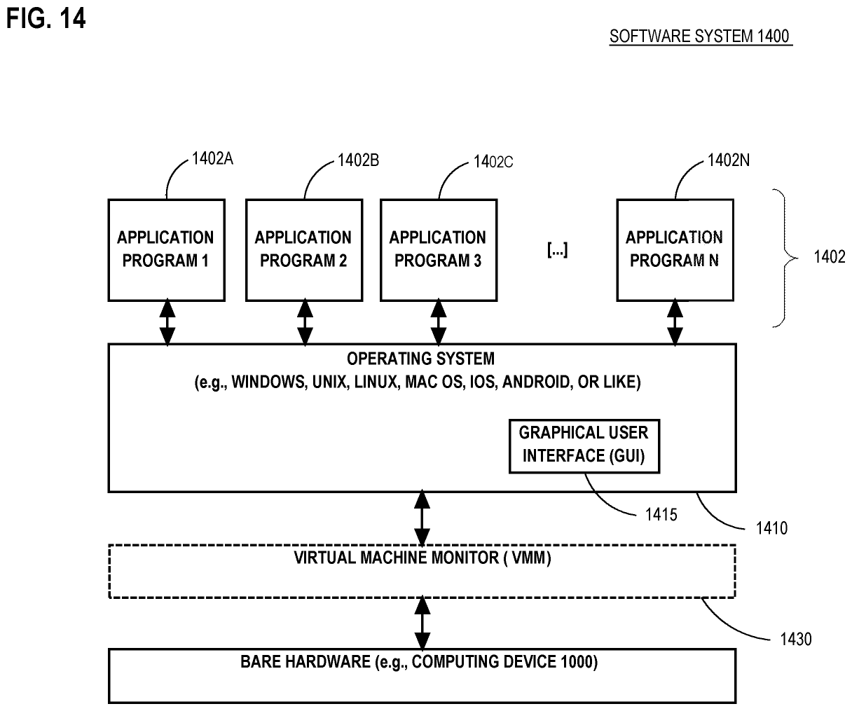

FIG. 14 is a block diagram of a basic software system 1400 that may be employed for controlling the operation of computing system 1300. Software system 1400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1400 is provided for directing the operation of computing system 1300. Software system 1400, which may be stored in system memory (RAM) 1306 and on fixed storage (e.g., hard disk or flash memory) 1310, includes a kernel or operating system (OS) 1410.

The OS 1410 manages low-level aspects of computer operation, including managing execution of processes, memory allocation, file input and output (I/O), and device I/O. One or more application programs, represented as 1402A, 1402B, 1402C . . . 1402N, may be “loaded” (e.g., transferred from fixed storage 1310 into memory 1306) for execution by the system 1400. The applications or other software intended for use on computer system 1300 may also be stored as a set of downloadable computer-executable instructions, for example, for downloading and installation from an Internet location (e.g., a Web server, an app store, or other online service).

Software system 1400 includes a graphical user interface (GUI) 1415, for receiving user commands and data in a graphical (e.g., “point-and-click” or “touch gesture”) fashion. These inputs, in turn, may be acted upon by the system 1400 in accordance with instructions from operating system 1410 and/or application(s) 1402. The GUI 1415 also serves to display the results of operation from the OS 1410 and application(s) 1402, whereupon the user may supply additional inputs or terminate the session (e.g., log off).

OS 1410 can execute directly on the bare hardware 1420 (e.g., processor(s) 1304) of computer system 1300. Alternatively, a hypervisor or virtual machine monitor (VMM) 1430 may be interposed between the bare hardware 1420 and the OS 1410. In this configuration, VMM 1430 acts as a software “cushion” or virtualization layer between the OS 1410 and the bare hardware 1420 of the computer system 1300.

VMM 1430 instantiates and runs one or more virtual machine instances (“guest machines”). Each guest machine comprises a “guest” operating system, such as OS 1410, and one or more applications, such as application(s) 1402, designed to execute on the guest operating system. The VMM 1430 presents the guest operating systems with a virtual operating platform and manages the execution of the guest operating systems.

In some instances, the VMM 1430 may allow a guest operating system to run as if it is running on the bare hardware 1420 of computer system 1300 directly. In these instances, the same version of the guest operating system configured to execute on the bare hardware 1420 directly may also execute on VMM 1430 without modification or reconfiguration. In other words, VMM 1430 may provide full hardware and CPU virtualization to a guest operating system in some instances.

In other instances, a guest operating system may be specially designed or configured to execute on VMM 1430 for efficiency. In these instances, the guest operating system is “aware” that it executes on a virtual machine monitor. In other words, VMM 1430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### CLOUD COMPUTING

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing, by a computer, a bipartite graph that consists of a source subgraph and a target subgraph,
wherein:
each vertex in the bipartite graph represents an entity,
the source subgraph and the target subgraph are connected by a plurality of similarity edges, and
each similarity edge of the plurality of similarity edges indicates an original amount of similarity between:
the entity of a source vertex of a plurality of source vertices in the source subgraph, and
the entity of a target vertex of a plurality of target vertices in the target subgraph;
for each similarity edge of the plurality of similarity edges, the computer determining:
a set of neighbor source vertices in the plurality of source vertices that are reachable from the source vertex of the similarity edge by traversing at most a source radius count of source edges in the source subgraph,
a set of neighbor target vertices in the plurality of target vertices that are reachable from the target vertex of the similarity edge by traversing at most a target radius count of target edges in the target subgraph,
a source amount of vertices in the set of neighbor source vertices that are connected to a vertex in the set of neighbor target vertices by a similarity edge,
a target amount of vertices in the set of neighbor target vertices that are connected to a vertex in the set of neighbor source vertices by a similarity edge, and
a lesser amount of vertices that is a minimum of the source amount of vertices and the target amount of vertices;
for each similarity edge of the plurality of similarity edges, the computer calculating a new amount of similarity based on said lesser amount.

2. The method of claim 1 wherein said calculating said new amount of similarity is further based on said original amount of similarity.

3. The method of claim 1 wherein:
the method further comprises summing, into a summed amount, the lesser amount of vertices of each similarity edge that is connected to a same source vertex of the plurality of source vertices;
said calculating said new amount of similarity is further based on said summed amount.

4. The method of claim 1 further comprising:
adding, to said set of neighbor source vertices, the set of neighbor source vertices of each neighbor source vertex in said set of neighbor source vertices;
adding, to said set of neighbor target vertices, the set of neighbor target vertices of each neighbor target vertex in said set of neighbor target vertices.

5. The method of claim 1 further comprising repeating:
said determining the set of neighbor source vertices with an increased value of said source radius count;
said determining the set of neighbor target vertices with an increased value of said target radius count.

6. The method of claim 5 wherein said repeating comprises repeating:
said determining said source amount of vertices;
said determining said target amount of vertices.

7. The method of claim 6 wherein:
the method further comprises assigning a weight to each vertex in the bipartite graph,
said determining said source amount of vertices is based on at least one selected from the group consisting of:
the weights of vertices in the set of neighbor source vertices,
the source amounts of vertices in the set of neighbor source vertices, and
counts of edges connecting the source vertex of the similarity edge to vertices of the set of neighbor source vertices;
said determining said target amount of vertices is based on at least one selected from the group consisting of:
the weights of vertices in the set of neighbor target vertices,
the target amounts of vertices in the set of neighbor target vertices, and
counts of edges connecting the target vertex of the similarity edge to vertices of the set of neighbor target vertices.

8. The method of claim 7 wherein said assigning the weight to each vertex in the bipartite graph comprises calculating an undirected PageRank of the vertex.

9. The method of claim 8 wherein said calculating the undirected PageRank of the vertex comprises calculating a negative exponent based on the undirected PageRank of the vertex.

10. The method of claim 9 wherein said calculating the negative exponent is further based on undirected PageRanks of the vertices in the bipartite graph.

11. The method of claim 1 wherein said calculating said new amount of similarity of each similarity edge of the plurality of similarity edges comprises normalizing said new amount of similarity based on the source vertex of said similarity edge and not based on other vertices of the bipartite graph.

12. The method of claim 11 wherein said normalizing said new amount of similarity based on the source vertex of said similarity edge comprises normalizing said new amount of similarity based solely on similarity edges connected to the source vertex of said similarity edge.

13. The method of claim 1 wherein said calculating said new amount of similarity comprises not increasing said new amount of similarity unless said lesser amount of vertices exceeds a threshold.

14. The method of claim 13 wherein said calculating said new amount of similarity of each similarity edge of the plurality of similarity edges comprises normalizing said new amount of similarity regardless of whether said lesser amount of vertices exceeds said threshold.

15. The method of claim 1 wherein said source radius count of source edges in the source subgraph exceeds said target radius count of target edges in the target subgraph.

16. One or more non-transitory computer-readable media storing instruction that, when executed by one or more processors, cause:
storing a bipartite graph that consists of a source subgraph and a target subgraph, wherein:
each vertex in the bipartite graph represents an entity,
the source subgraph and the target subgraph are connected by a plurality of similarity edges, and
each similarity edge of the plurality of similarity edges indicates an original amount of similarity between:
the entity of a source vertex of a plurality of source vertices in the source subgraph, and
the entity of a target vertex of a plurality of target vertices in the target subgraph;
for each similarity edge of the plurality of similarity edges, determining:
a set of neighbor source vertices in the plurality of source vertices that are reachable from the source vertex of the similarity edge by traversing at most a source radius count of source edges in the source subgraph,
a set of neighbor target vertices in the plurality of target vertices that are reachable from the target vertex of the similarity edge by traversing at most a target radius count of target edges in the target subgraph,
a source amount of vertices in the set of neighbor source vertices that are connected to a vertex in the set of neighbor target vertices by a similarity edge,
a target amount of vertices in the set of neighbor target vertices that are connected to a vertex in the set of neighbor source vertices by a similarity edge, and
a lesser amount of vertices that is a minimum of the source amount of vertices and the target amount of vertices;
for each similarity edge of the plurality of similarity edges, the computer calculating a new amount of similarity based on said lesser amount.

17. The one or more non-transitory computer-readable media of claim 16 wherein said calculating said new amount of similarity is further based on said original amount of similarity.

18. The one or more non-transitory computer-readable media of claim 16 wherein:
the instructions further cause summing, into a summed amount, the lesser amount of vertices of each similarity edge that is connected to a same source vertex of the plurality of source vertices;
said calculating said new amount of similarity is further based on said summed amount.

19. The one or more non-transitory computer-readable media of claim 16 wherein the instructions further cause:
adding, to said set of neighbor source vertices, the set of neighbor source vertices of each neighbor source vertex in said set of neighbor source vertices;
adding, to said set of neighbor target vertices, the set of neighbor target vertices of each neighbor target vertex in said set of neighbor target vertices.

20. The one or more non-transitory computer-readable media of claim 16 wherein the instructions further cause:
said determining the set of neighbor source vertices with an increased value of said source radius count;
said determining the set of neighbor target vertices with an increased value of said target radius count.
